(19) United States
(12) Patent Application Publication
(10) Pub. No.: US 2026/0037620 A1
(43) Pub. Date: Feb. 5, 2026

(54) Systems and Methods for Labeling Event Data Obtained from a Computing Environment Using Artificial Intelligence

(71) Applicant: Crowdstrike, Inc., Sunnyvale, CA (US)

(72) Inventors: Olga Ewa GDULA, Reading (GB); Arnd KORN, Berlin (DE)

(21) Appl. No.: 18/789,375

(22) Filed: Jul. 30, 2024

(51) Int. Cl. G06F 21/55

(52) U.S. Cl. CPC G06F 21/554; G06F 2221/034

(57) ABSTRACT

A computer-implemented method for a digital security system receives unlabeled event data associated with a computing environment, clusters via an unsupervised machine learning model the unlabeled event data into clusters of unlabeled event data where unlabeled event data in one cluster are more similar to each other than to unlabeled event data in other clusters, selects a respective subset of unlabeled event data for each cluster of unlabeled event data, translates via a large language model artificial neural network each unlabeled event datum in each respective subset of unlabeled event data into a description for the unlabeled event datum, and applies a label via a labeling algorithm to at least one unlabeled event datum in a respective cluster responsive to and representative of the respective description for the unlabeled event datum in the respective subset, thereby transforming the at least one unlabeled event datum to a labeled event datum.

### TECHNICAL FIELD

Embodiments of the invention relate to systems and methods that can receive unlabeled event data from a computing environment, translate the unlabeled event data into a description using a large language model, and apply a label to the event data based on the corresponding description.

### BACKGROUND

Given the rise in fileless cybersecurity attacks, such as “living off the land” attacks that use existing, legitimate, tools on a computing device, and hands-on-keyboard activity, cybersecurity experts are actively developing new Machine Learning (ML) approaches for detecting and mitigating fileless attacks, including approaches based on artificial intelligence (AI)-powered indicators of attack (IOAs).

To that end, labeled data can be used either directly in training new ML models, or to improve existing ML models by providing contextual information on entity or event subpopulations, techniques, and tactics.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example architecture of a distributed security system in which embodiments of the present disclosure may be used.

FIG. 2A illustrates a flowchart of a method to apply a label via a labeling algorithm to at least one unlabeled event datum in a cluster responsive to and representative of a respective description for the unlabeled event datum, according to an embodiment of the present disclosure.

FIG. 2B illustrates a flowchart of a method to apply a label via a labeling algorithm to unlabeled event datum in a cluster responsive to and representative of a respective description for the unlabeled event datum, according to one or more embodiments of the present disclosure.

FIG. 3 illustrates a flowchart for translating via a large language model artificial neural network unlabeled event datum into one or more descriptions for the unlabeled event datum according to example embodiments of the present disclosure.

FIG. 4 illustrates a flowchart for applying a label via a labeling algorithm to unlabeled event datum according to example embodiments of the present disclosure.

FIG. 5 illustrates an example system architecture for a client device.

### DETAILED DESCRIPTION

Given the rise in fileless cybersecurity attacks, such as “living off the land” attacks that use existing, legitimate, tools on a computing device, and hands-on-keyboard activity, cybersecurity experts are actively developing new Machine Learning (ML) approaches for detecting and mitigating fileless attacks, including approaches based on artificial intelligence (AI)-powered indicators of attack (IOAs). However, research and development in this area is hampered by the scarcity of labeled data. This is particularly acute in ML models based on entities or events which are not directly associated with a labeled binary file, including ML models that operate on command lines or command line lineage from a process tree. Creating labels, in particular, creating reliable labels, for such ML models requires significant cybersecurity analyst time and expertise, since specific, subtle, intricate details of a command line or process tree can indicate anomalous or malicious behavior, or not. Reliance on human experts limits the ability to build the large corpora of labeled entities or events (such as command lines or process trees) that are required for superior ML model performance.

Furthermore, the amount of information on which to base the label is relatively small and not always apparent, due to the length of command lines, and due to them containing names of binaries or options which require deep understanding of how they function, to determine whether the particular command line indicates anomalous or malicious activity. At the same time, a live stream of new entities or events encountered on client devices or endpoints is expected to contain a large proportion of highly similar entities or events (for example, comparable command lines with variations in image file names and subfolders). Taken together, the amount of new data in the live stream, the likely similarity of the data, and the need for interpretation and contextualization of the data call for a novel approach to suggest labels that can be either binary (e.g., malicious/benign), or multi-class/multi-label (e.g., indicating the type of malicious behavior by mapping the behavior to the Adversarial Tactics, Techniques, and Common Knowledge (MITRE ATT&CK), a guideline for classifying and describing cyberattacks and intrusions, created by the Mitre Corporation and released in 2013).

The disclosed embodiments leverage an unsupervised Machine Learning (ML) method (similarity/clustering), a Large Language Model (LLM) artificial neural networks (ANN) (or, simply, an LLM), and an additional method, such as a supervised ML or rule-based approach, to create a workflow for labeling entities or events such as command lines and process trees. This workflow provides the ability to operate at scale, something that even a team of cybersecurity analysts working together cannot accomplish via manual efforts alone. The workflow reduces the labeling cost associated with a supervised ML, while also automating the process of labeling data, which can be subject to human review, to create labeled corpora at scale.

The workflow uses a variety of ML techniques to automate the process of labeling entities such as command lines or process trees. The workflow is not aimed at directly producing detections on live data streams, since this would be prohibitively costly. Instead, the aim of the workflow is to automate the triage and labeling process for data to be used in training simpler and more lightweight production ML models.

Generally, the workflow involves using an unsupervised ML algorithm to group together similar entities or events. The aim of this step is to reduce the number of entities sent to the next stage, by selecting only a subset of them per each group. This step aims to target entities or events in areas of interest for further processing while filtering out known and related entities (via, for example, but not limited to, approximate nearest neighbor lookup and majority voting to infer a label of a new entity without additional processing).

Another step of the workflow takes filtered entities or events of interest and translates the command line/process tree into natural language using an LLM. The output provides a description of the behavior of the command line/process tree, and can include further explanations, such as explaining the typical usage of the binary (executable) file being run or executed in the command line, or its options, or an indication of whether the usage is common or indicative of anomalous or malicious behavior. Additionally, the output may include a level of confidence in the interpretation and description.

Yet another step of the workflow uses a labeling algorithm such as a rule-based system or classification model on the output from the second step, with the aim of determining a label or metadata to capture the characteristics of interest of the entity or event. This label may be a binary label (e.g., simply indicating whether the entity or event is benign or malicious), or a multi-class label (e.g., indicating a type of behavior such as reconnaissance/lateral movement, etc.), or a multi-label (e.g., indicating several nonexclusive labels to assign to the instance such as obfuscation_via_base64, or registry_modification). The workflow is not prescriptive about the specific nature of the final model. The final model, for example, may be a separate LLM model trained on cybersecurity domain knowledge, or a supervised ML algorithm (if some initial labels are available), or an unsupervised ML algorithm, such as an unsupervised sentiment analyzing algorithm or a rule-based engine. The output labels aid and support cybersecurity researchers and threat experts in practically managing a considerable stream of entities or events by providing relevant metadata to speed up the triage and review process.

According to an embodiment, a computer-implemented method is provided for a digital security system to receive unlabeled event data associated with a computing environment, cluster via an unsupervised machine learning model the unlabeled event data into clusters of unlabeled event data where unlabeled event data in one cluster are more similar to each other than to unlabeled event data in other clusters, select a respective subset of unlabeled event data for each cluster of unlabeled event data, translate via a large language model artificial neural network each unlabeled event datum in each respective subset of unlabeled event data into a description for the unlabeled event datum, and apply a label via a labeling algorithm to at least one unlabeled event datum in a respective cluster responsive to and representative of the respective description for the unlabeled event datum in the respective subset, thereby transforming the at least one unlabeled event datum to a labeled event datum.

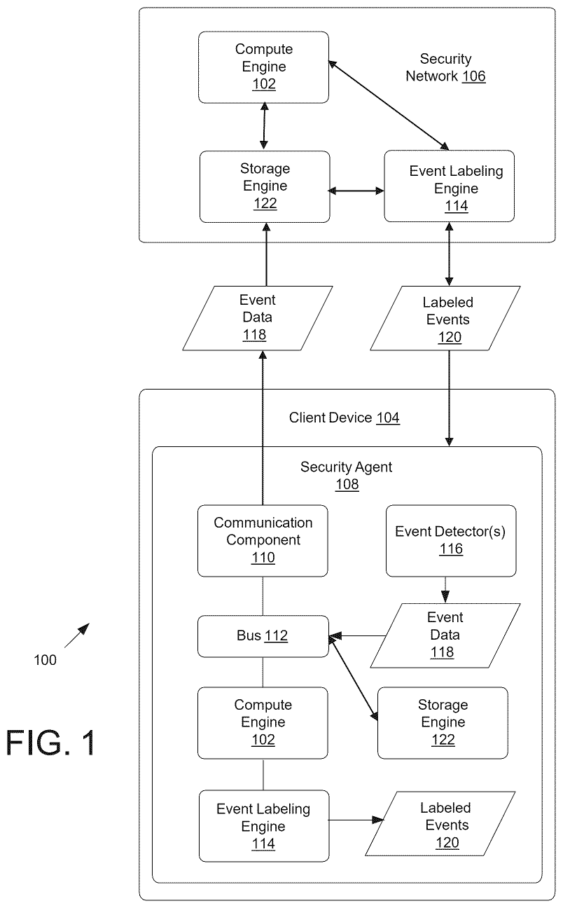

FIG. 1 depicts an example of a distributed security system 100 in which embodiments of the present disclosure may be deployed. The distributed security system 100 can include distributed instances of a compute engine 102 that can run locally on one or more client computing devices 104, or simply, client devices 104, and/or in a security network 106. As an example, some instances of the compute engine 102 can run locally on client devices 104 as part of security agents, or sensors 108, executing on those client devices 104. As another example, other instances of the compute engine 102 can run remotely in a security network 106, for instance within a cloud computing environment associated with the distributed security system 100. The compute engine 102 can execute according to portable computer executable code that can run locally as part of a security agent 108, in a security network 106, and/or in other local or network systems that can also process event data as described herein.

Likewise, the distributed security system 100 can include distributed instances of an events labeling engine 114 that can run locally on one or more client devices 104, and/or in a security network 106. As an example, some instances of the events labeling engine 114, or portions thereof, can run locally on client devices 104 as part of security agents 108 executing on those client devices 104. As another example, other instances of the events labeling engine 114, or portions thereof, can run remotely in a security network 106, for instance within a cloud computing environment associated with the distributed security system 100. The events labeling engine 114 can execute according to portable computer executable code that can run locally as part of a security agent 108, in a security network 106, and/or in other local or network systems that can also process event data as described herein.

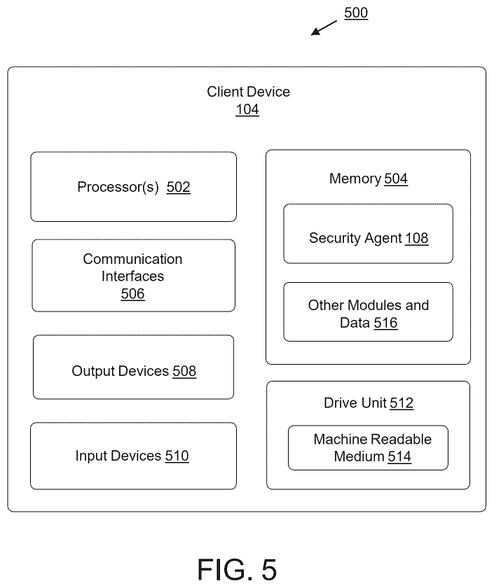

A client device 104 can include or be one or more computing devices. In various examples, a client device 104 can be a workstation, a personal computer (PC), a laptop computer, a tablet computer, a personal digital assistant (PDA), a cellular phone, a media center, an Internet of Things (IoT) device, a server or server farm, multiple distributed server farms, a mainframe, or any other sort of computing device or computing devices or combinations thereof. In some examples, a client device 104 can be a computing device, component, or system that is embedded or otherwise incorporated into another device or system. In some examples, the client device 104 can also be a standalone or embedded component that processes or monitors incoming and/or outgoing data communications. For example, the client device 104 can be a network firewall, network router, network monitoring component, a supervisory control and data acquisition (SCADA) component, or any other component. An example system architecture for a client device 104 is illustrated in greater detail in FIG. 5 and is described in detail below with reference to that figure.

The security network 106 can include one or more servers, server farms, hardware computing elements, virtualized computing elements, and/or other network computing elements that are remote from the client devices 104. In some examples, the security network 106 can be a cloud or a cloud computing environment. Client devices 104, and/or security agents 108 executing on such client devices 104, can communicate with elements of the security network 106 through the Internet or other types of network and/or data connections. In some examples, computing elements of the security network 106 can be operated by, or be associated with, an operator of a security service, while the client devices 104 can be associated with customers, subscribers, and/or other users of the security service.

As shown in FIG. 1, instances of the compute engine 102 can execute locally on client devices 104 as part of security agents 108 deployed as runtime executable applications that run locally on the client devices 104. Local instances of the compute engine 102 may execute in security agents 108 on a homogeneous or heterogeneous set of client devices 104. Similarly, instances of the events labeling engine 114 can execute locally on client devices 104 as part of security agents 108 deployed as runtime executable applications that run locally on the client devices 104. Local instances of the events labeling engine 114 may execute in security agents 108 on a homogeneous or heterogeneous set of client devices 104.

One or more cloud instances of the compute engine 102 can also execute on one or more computing elements of the security network 106, remote from client devices 104. The distributed security system 100 can also include a set of other cloud elements that execute on, and/or are stored in, one or more computing elements of the security network 106. For example, the cloud elements of the security network 106 can include an events labeling engine 114 and a storage engine 122, as discussed further below.

Local and/or cloud instances of the compute engine 102, and/or other elements of the distributed security system 100 such as events labeling engine 114, can process event data 118 about single events and/or patterns of events that occur on one or more client devices 104. Events can include any observable and/or detectable type of computing operation, networking operation, behavior, or other action that may occur on or in connection with one or more client devices 104. According to embodiments of the present disclosure, events can include events and behaviors such as command line events, process trees, or events associated with file system operations, including creating, downloading, uploading, reading, writing (or otherwise modifying), copying, importing, or exporting a file, or parts thereof, or moving the location of a file either within a file directory structure or to another file directory structure on the same or different client device 104. By way of non-limiting examples, an event may be a process that ran or executed a command, process, or executable file, or created a file, wrote to the file, and saved the file on the client device 104, or opened an existing file, modified the existing file, and/or saved the existing file under the same or different name and/or with the same or different file extension on the client device 104 or on another client device 104. In some examples, events based on other such observable or detectable occurrences can be or include physical and/or hardware events. For instance, the event may be that a Universal Serial Bus (USB) memory stick or other USB device was inserted in, or removed from, a client device 104, particularly when the event occurs in conjunction with recent file system operations such as dragging and/or dropping files between the USB device and a permanent storage device or other drive unit of the client device 104.

Events that occur on or in connection with one or more client devices 104 can be detected or observed by event detectors 116 of security agents 108 on those client devices 104. For example, a security agent 108 may execute at a kernel-level and/or as a driver such that the security agent 108 has visibility into operating system activities from which one or more event detectors 116 of the security agent 108 can observe event occurrences or derive or interpret the occurrences of events. In some examples, the security agent 108 may load at the kernel-level at boot time of the client device 104, before or during loading of an operating system, such that the security agent 108 includes kernel-mode components such as a kernel-mode event detector 116. In some examples, a security agent 108 can also, or alternately, have components that operate on a computing device in a user-mode, such as user-mode event detectors 116 that can detect or observe user actions and/or user-mode events.

When an event detector 116 of a security agent 108 detects or observes a behavior or other event that occurs on a client device 104, the security agent 108 can place corresponding event data 118 about the event occurrence on a bus 112 or other memory location. For instance, in some examples the security agent 108 may have a local version of a storage engine 122 described herein below or have access to other local memory on the client device 104, where the security agent 108 can at least temporarily store event data 118. The event data 118 on the bus 112, or stored at another memory location, can be accessed by other elements of the security agent 108, including an instance of the compute engine 102, and/or a communication component 110 that can send the event data 118 to the security network 106, and/or an instance of events labeling engine 114.

Each security agent 108 can have a unique identifier, such as an agent identifier (AID). Accordingly, distinct security agents 108 on different client devices 104 can be uniquely identified by other elements of the distributed security system 100 using an AID or other unique identifier, or a combination of an AID and another unique identifier, such as a client device identifier or network and/or IP address associated with the client device. In this manner, event data 118 and/or labeled event data 120, for example, related to command line events, process trees, or file system operations involving one or more files, can be associated with a particular client device and/or security agent.

In some examples, event data 118 about events detected or observed locally on a client device 104, can be processed locally by a compute engine 102 and/or other elements of a local security agent 108 executing on that client device 104. However, in some examples, event data 118 about locally occurring events can also, or alternately, be sent by a security agent 108 on a client device 104 to the security network 106, such that the event data 118 can be processed by a cloud instance of the compute engine 102 and/or other cloud elements of the distributed security system 100, such as events labeling engine 114. Accordingly, event data 118 about events that occur locally on client devices 104 can be processed locally by security agents 108, be processed remotely via cloud elements of the distributed security system 100 or be processed by both local security agents 108 and cloud elements of the distributed security system 100.

The storage engine 122 can process and/or manage event data 118 that is sent to the security network 106 by client devices 104. In some examples, the storage engine 122 can receive event data 118 from security agents 108 provided by an operator of a security service that also runs the security network 106. However, in other examples, the storage engine 122 can also receive and process event data 118 from any other source, including an instance of compute engine 102 executing in security network 106, an instance of the events labeling engine 114 executing in security network 106, security agents 108 associated with other vendors or streams of event data 118 from other providers.

The storage engine 122 can operate on event data. In particular, storage engine 122 can sort incoming event data 118, route event data 118 to corresponding instances of the compute engine 102, store event data 118 in short-term and/or long-term storage, output event data 118 to other elements of the distributed security system 100, such as instances of the events labeling engine 114, and/or perform other types of storage operations.

A compute engine 102 in the distributed security system 100 can process an event stream of event data 118. The event data 118 may have originated from an event detector 116 of a security agent 108 that initially detected or observed the occurrence of an event on a client device 104, and/or may be event data 118 that has been produced by a different instance of the compute engine 102. In a local instance of the compute engine 102 (i.e., an instance of compute engine 102 operating on a client device 104), in some examples the event stream may be received from a bus 112 or local memory on a client device 104. In a cloud instance of the compute engine 102, in some examples the event stream may be received via the storage engine 122.

The compute engine 102 can generate a result from event data 118 in an event stream. For example, if the event stream includes event data 118 indicating that one or more events occurred that match a behavior pattern, the compute engine 102 can generate and output a result indicating that there is a match with the behavior pattern. In some examples, the result can itself be new event data 118 specifying that a behavior pattern has been matched, and/or, for example, the result can be a feature vector associated with the event, as described further below. The generated results may be stored in storage engine 122, for example, for subsequent input to an instance of compute engine 102 or an instance of events labeling engine 114.

According to embodiments of the present disclosure, an input event stream of event data 118 can be sent to the security network 106 by one or more local security agents 108. Such an input event stream of event data 118 can be received by a storage engine 122 in the security network 106, as shown in FIG. 1. In some examples, security agents 108 can send event data 118 to the security network 106 over a temporary or persistent connection, and a termination service or process of the distributed security system 100 can provide event data 118 received from multiple security agents 108 to the storage engine 122 as an input event stream.

The event data 118 in the input event stream may be in a random or pseudo-random order when it is received by the storage engine 122 in the security network 106. For example, event data 118 for different events may arrive at the storage engine 122 in the input event stream in any order without regard for when the events occurred on client devices 104. As another example, event data 118 from security agents 108 on different client devices 104 may be mixed together within the input event stream when they are received at the storage engine 122, without being ordered by identifiers of the security agents 108. However, the storage engine 122 can perform various operations to sort, route, and/or store the event data 122 within the security network 106.

Digital security systems may find it challenging to process event data to accurately distinguish between legitimate or malicious or anomalous behavior in the event data, for example, because malware and threat actor behavior is rapidly changing. What is needed, and what is provided by the example embodiments described below, is an evaluation of event data that can uncover known malicious or anomalous behaviors, new variations of such known behaviors, and new or previously unknown or undetected malicious or anomalous behavior. To that end, sensors, or security agents 108, on client computing devices 104 collect event data and transmit that event data 118 to local instances of compute engine 102 and/or remote instances of compute engine 102 in security network 106. Once received at a compute engine, the event data can be manipulated to generate results, such as feature vectors, which can then be transmitted to local instances of events labeling engine 114 and/or remote instances of events labeling engine 114 in security network 106. The events labeling engine 114 can process the results received from compute engine 102 and generate labeled event data 120.

The labeled event data 120 can be transmitted back to selected client devices 104 where the information can inform practices and generation of threat detection rules logic on the client devices to more accurately counter or pre-empt the occurrence of new or repeated but previously undetected attacks or malicious or anomalous behavior.

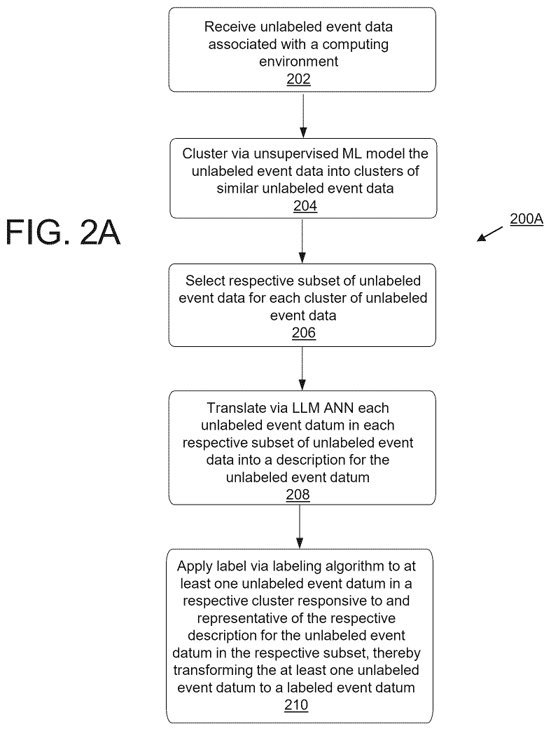

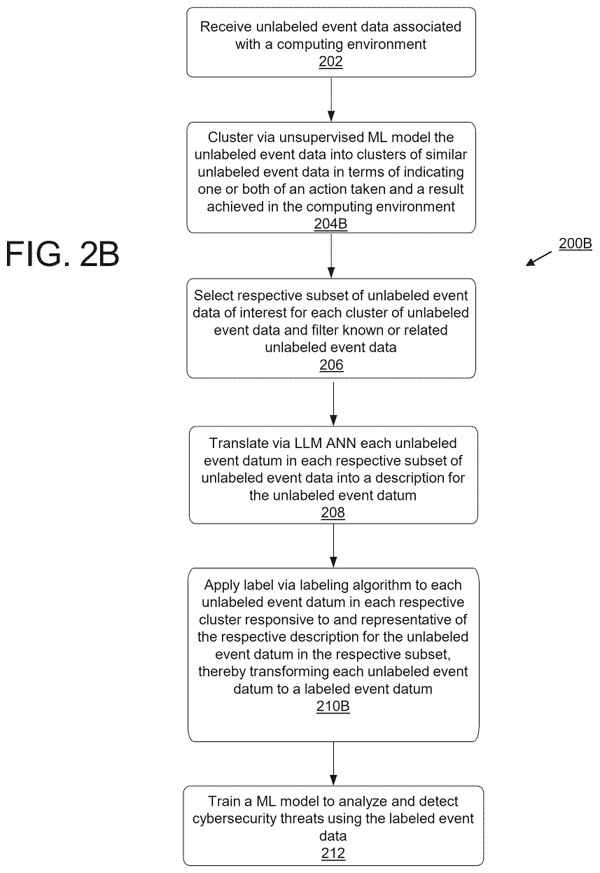

With reference to flowchart 200A in FIG. 2A, embodiments include a computer-implemented method for a digital security system to receive at block 202 unlabeled event data associated with a computing environment, such as command line events or process tree events occurring at or on client devices 104. For example, compute engine 102 in security network 106 may receive such unlabeled event data from one or more client devices 104. The process continues at block 204 by clustering via an unsupervised machine learning model (ML) the unlabeled event data into clusters of unlabeled event data where unlabeled event data in one cluster are more similar to each other than to unlabeled event data in other clusters. In one embodiment, the unsupervised ML model may by operated by compute engine 102, or events labeling engine 114 in security network 106.

In general, there are several approaches that may be used for clustering at block 204. Without being overly prescriptive, most approaches process the event data into a feature vector (containing numeric components). The vector, for example, can use counts of different words, or parts of words, of interest that are present in a given datum; and/or match to specific character patterns indicated by regular expressions; and/or can use, for example, numbers reflecting the values from complex mathematical transformations (such as embeddings), and/or numbers reflecting values of statistical functions performed on fields of the datum (such as the length of the field, the number of digits etc.). The vector representation of event data 118 can be used with either: 1) a distance metric where lower values of distance represent greater similarity (a metric that measures dissimilarity), or 2) a similarity metric where greater values represent greater similarity (for example, the well-known cosine similarity function). In addition to cosine similarity, there are other types of similarity algorithms that may be used, according to embodiments, such as those based on distances to nearest neighbors, those based on the distance to the nearest cluster mean (“K-means clustering”), as well as algorithms which determine similarity based on traversing a decision tree ML model trained on labeled data. In general, the type of algorithm used for clustering may depend on the type of event/data being evaluated.

Embodiments then select, at block 206, a respective subset of unlabeled event data for each cluster of unlabeled event data. In one embodiment, selecting the respective subset of unlabeled event data for each cluster of unlabeled event data, may involve one or both of selecting unlabeled event data of interest and filtering out known or related unlabeled event data.

The process continues, at block 208, translating via a large language model artificial neural network (LLM) each unlabeled event datum in each respective subset of unlabeled event data into a description for the unlabeled event datum. Finally, at block 210, embodiments, apply a label via a labeling algorithm to at least one unlabeled event datum in a respective cluster responsive to and representative of the respective description for the unlabeled event datum in the respective subset, thereby transforming the at least one unlabeled event datum to a labeled event datum. According to one embodiment, the selection process, the translation process, and the label application process are performed by events labeling engine 114. In one embodiment, this label may be applied through processing with a distinct labeling algorithm that is different and separate from any algorithm(s) involved in process steps 202-208.

With reference to flowchart 200 in FIG. 2B, according to an embodiment, the labeled event data may be output at 120, where it may be used, for example, at block 212 in training a machine learning model to analyze and detect cybersecurity threats using the labeled event data.

Further with reference to flowchart 200B in FIG. 2B, according to an embodiment, applying at block 210 the label via the labeling algorithm to the at least one unlabeled event datum in the respective cluster responsive to and representative of the respective description for the unlabeled event datum in the respective subset, involves applying, at block 210B, a label via the labeling algorithm to a plurality of unlabeled event datum in each respective cluster responsive to and representative of the respective description for the unlabeled event datum in the respective subset. In one example, the label applied via the labeling algorithm to the plurality of unlabeled event datum in a given cluster may be an identical label. However, in another example, different labels may be applied to different unlabeled event datum in the same cluster. For example, a first label may be applied via the labeling algorithm to one or more of the unlabeled event datum in a cluster, and a second label, different than the first label, may be applied via the labeling algorithm to another one or more of the unlabeled event datum in the same cluster. In this latter example, it is contemplated that the labeling algorithm may receive input that identifies what labels to apply to which unlabeled event datum in the cluster. For example, a voting scheme, such as a majority voting scheme, may decide what labels to apply to unlabeled event datum in the cluster. The voting scheme may base the vote on an underlying similarity or distance metric associated with each unlabeled event datum in the cluster. For example, a K-nearest neighbor algorithm may calculate a distance metric for each unlabeled event datum and the voting scheme applies one or another label to an unlabeled event datum in the same cluster based on such.

Further with reference to FIG. 2B, according to an embodiment, clustering at block 204 via the unsupervised machine learning model the unlabeled event data into clusters of unlabeled event data where unlabeled event data in one cluster are more similar to each other than to unlabeled event data in other clusters, involves, at block 204B, clustering via the unsupervised machine learning model the unlabeled event data into clusters of unlabeled event data where unlabeled event data in one cluster are more similar to each other in terms of indicating one or both of an action taken and a result achieved in the computing environment than to unlabeled event data in other clusters.

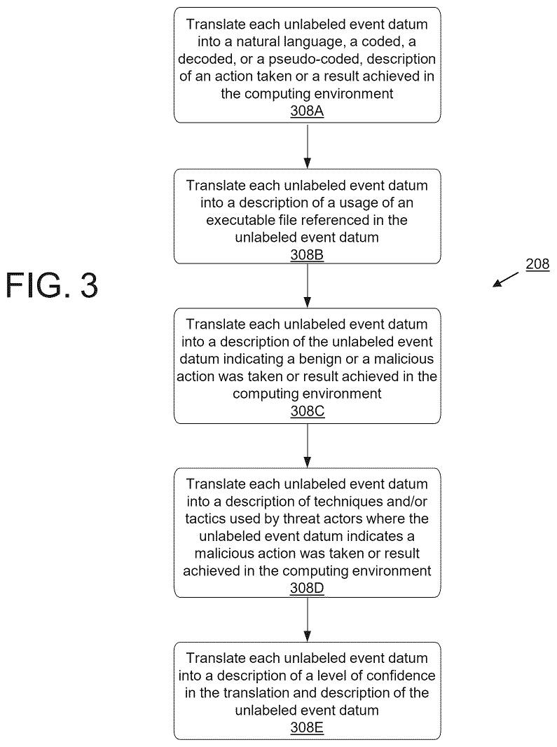

With reference to FIG. 3, according to embodiments, translating at block 208 via the large language model artificial neural network each unlabeled event datum in each respective subset of unlabeled event data into the description for the unlabeled event datum, involves translating each unlabeled event datum into one or more of: a natural language, a coded, a decoded, or a pseudo-coded, description of an action taken or a result achieved in the computing environment (block 308A); a description of a usage of an executable file referenced in the unlabeled event datum (block 308B); a description of the unlabeled event datum indicating a benign or a malicious action was taken or result achieved in the computing environment (block 308C); a description of techniques and/or tactics used by threat actors where the unlabeled event datum indicates a malicious action was taken or result achieved in the computing environment (block 308D); and a description of a level of confidence in the translation and description of the unlabeled event datum (block 308E).

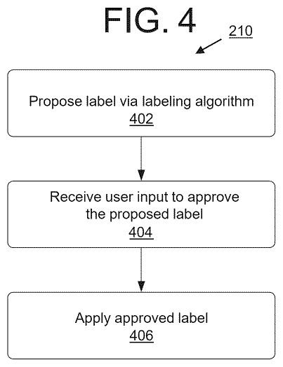

With reference to FIG. 4, according to an embodiment, applying at block 210 a label via the labeling algorithm to the at least one unlabeled event datum in the respective cluster responsive to and representative of the respective description for the unlabeled event datum in the respective subset, thereby transforming the at least one unlabeled event datum to the labeled event datum, involves events labeling engine, at block 402, proposing the label via the labeling algorithm, receiving user input at the events labeling engine which, at block 404, approves the proposed label, and applying, at block 406, via the events labeling engine the approved label.

Embodiments contemplate applying various types of labels to unlabeled event datum, including, for example, a binary label that indicates the unlabeled event datum to which the binary label is being applied indicates one of a benign or a malicious action taken or result achieved in the computing environment, a multiple class label that indicates the unlabeled event datum to which the multiple class label is being applied indicates one of a plurality of actions taken, or results achieved in the computing environment (for example, the label may indicate actions such as file discovery, network discovery, process discovery, or file removal), and a multiple label that indicates the unlabeled datum to which the multiple label is being applied indicates a plurality of event characteristics, actions taken, or results achieved in the computing environment (for example, an obfuscated command, a malicious action, a data encryption action, or an impact of an action).

FIG. 5 depicts an example system architecture 500 for a client device 104. A client device 104 can be one or more computing devices, such as a workstation, a personal computer (PC), a laptop computer, a tablet computer, a personal digital assistant (PDA), a cellular phone, a media center, an embedded system, a server or server farm, multiple distributed server farms, a mainframe, or any other type of computing device. As shown in FIG. 5, a client device 104 can include processor(s) 502, memory 504, communication interface(s) 506, output devices 508, input devices 510, and/or a drive unit 512 including a machine readable medium 514.

In various examples, the processor(s) 502 can be a central processing unit (CPU), a graphics processing unit (GPU), or both CPU and GPU, or any other type of processing unit. Each of the one or more processor(s) 502 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 502 may also be responsible for executing drivers and other computer-executable instructions for applications, routines, or processes stored in the memory 504, which can be associated with common types of volatile (RAM) and/or nonvolatile (ROM) memory.

In various examples, the memory 504 can include system memory, which may be volatile (such as RAM), non-volatile (such as ROM, flash memory, etc.) or some combination of the two. Memory 504 can further include non-transitory computer-readable media, such as volatile and nonvolatile, removable and non-removable media implemented in any method or technology for storage of information, such as computer-readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information and which can be accessed by the client device 104. Any such non-transitory computer-readable media may be part of the client device 104.

The memory 504 can store data, including computer-executable instructions, for a security agent 108 as described herein. The memory 504 can further store event data 118, and/or other data being processed and/or used by one or more components of the security agent 108, including event detectors 116, a compute engine 102, and a communication component 110. The memory 504 can also store any other modules and data 516 that can be utilized by the client device 104 to perform or enable performing any action taken by the client device 104. For example, the modules and data can be a platform, operating system, and/or applications, as well as data utilized by the platform, operating system, and/or applications.

The communication interfaces 506 can link the client device 104 to other elements through wired or wireless connections. For example, communication interfaces 506 can be wired networking interfaces, such as Ethernet interfaces or other wired data connections, or wireless data interfaces that include transceivers, modems, interfaces, antennas, and/or other components, such as a Wi-Fi interface. The communication interfaces 506 can include one or more modems, receivers, transmitters, antennas, interfaces, error correction units, symbol coders and decoders, processors, chips, application specific integrated circuits (ASICs), programmable circuit (e.g., field programmable gate arrays), software components, firmware components, and/or other components that enable the client device 104 to send and/or receive data, for example to exchange event data 118, and/or any other data with the security network 106.

The output devices 508 can include one or more types of output devices, such as speakers or a display, such as a liquid crystal display. Output devices 508 can also include ports for one or more peripheral devices, such as headphones, peripheral speakers, and/or a peripheral display. In some examples, a display can be a touch-sensitive display screen, which can also act as an input device 510.

The input devices 510 can include one or more types of input devices, such as a microphone, a keyboard or keypad, and/or a touch-sensitive display, such as the touch-sensitive display screen described above.

The drive unit 512 and machine readable medium 514 can store one or more sets of computer-executable instructions, such as software or firmware, that embodies any one or more of the methodologies or functions described herein. The computer-executable instructions can also reside, completely or at least partially, within the processor(s) 502, memory 504, and/or communication interface(s) 506 during execution thereof by the client device 104. The processor(s) 502 and the memory 504 can also constitute machine readable media 514.

Some or all operations of the methods described above can be performed by execution of computer-readable instructions stored on a computer-readable storage medium, as defined below. The term “computer-readable instructions” as used in the description and claims, include routines, applications, application modules, program modules, programs, components, data structures, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (“RAM”)) and/or non-volatile memory (such as read-only memory (“ROM”), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer-readable storage media do not include communication media.

The computer-readable instructions stored on one or more non-transitory computer-readable storage media that, when executed by one or more processors, may perform operations described above with reference to FIGS. 2A, 2B, 3 and 4. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter is not necessarily limited to the specific features or acts described above. Rather, the specific features and acts described above are disclosed as example embodiments.

What is claimed is:

1. A computer-implemented method for a digital security system, the method comprising:
receiving unlabeled event data associated with a computing environment;
clustering via an unsupervised machine learning model the unlabeled event data into clusters of unlabeled event data where unlabeled event data in one cluster are more similar to each other than to unlabeled event data in other clusters;
selecting a respective subset of unlabeled event data for each cluster of unlabeled event data;
translating via a large language model artificial neural network each unlabeled event datum in each respective subset of unlabeled event data into a description for the unlabeled event datum; and
applying a label via a labeling algorithm to at least one unlabeled event datum in a respective cluster responsive to and representative of the respective description for the unlabeled event datum in the respective subset, thereby transforming the at least one unlabeled event datum to a labeled event datum.

2. The computer-implemented method of claim 1 wherein applying the label via the labeling algorithm to the at least one unlabeled event datum in the respective cluster responsive to and representative of the respective description for the unlabeled event datum in the respective subset, comprises applying a label via the labeling algorithm to a plurality of unlabeled event datum in each respective cluster responsive to and representative of the respective description for the unlabeled event datum in the respective subset.

3. The computer-implemented method of claim 2, wherein applying the label via the labeling algorithm to the plurality of unlabeled event datum in each respective cluster responsive to and representative of the respective description for the unlabeled event datum in the respective subset, comprises applying a first label via the labeling algorithm to one or more of the unlabeled event datum in a given cluster, and applying a second label, different than the first label, via the labeling algorithm to another one or more of the unlabeled event datum in the given cluster.

4. The computer-implemented method of claim 1 further comprising training a machine learning model to analyze and detect cybersecurity threats using the labeled event data.

5. The computer-implemented method of claim 1 wherein clustering via the unsupervised machine learning model the unlabeled event data into clusters of unlabeled event data where unlabeled event data in one cluster are more similar to each other than to unlabeled event data in other clusters, comprises clustering via the unsupervised machine learning model the unlabeled event data into clusters of unlabeled event data where unlabeled event data in one cluster are more similar to each other in terms of indicating one or both of an action taken and a result achieved in the computing environment than to unlabeled event data in other clusters.

6. The computer-implemented method of claim 1, wherein selecting the respective subset of unlabeled event data for each cluster of unlabeled event data, comprises one or both of selecting unlabeled event data of interest and filtering out known or related unlabeled event data.

7. The computer-implemented method of claim 1, wherein translating via the large language model artificial neural network each unlabeled event datum in each respective subset of unlabeled event data into the description for the unlabeled event datum, comprises translating each unlabeled event datum into one or more of: a natural language, a coded, a decoded, or a pseudo-coded, description of an action taken or a result achieved in the computing environment; a description of a usage of an executable file referenced in the unlabeled event datum; a description of the unlabeled event datum indicating a benign or a malicious action was taken or result achieved in the computing environment; a description of techniques and/or tactics used by threat actors where the unlabeled event datum indicates a malicious action was taken or result achieved in the computing environment; and a description of a level of confidence in the translation and description of the unlabeled event datum.

8. The computer-implemented method of claim 1, wherein applying the label via the labeling algorithm to the at least one unlabeled event datum in the respective cluster responsive to and representative of the respective description for the unlabeled event datum in the respective subset, thereby transforming the at least one unlabeled event datum to the labeled event datum, comprises:
proposing the label via the labeling algorithm;
receiving user input to approve the proposed label; and
applying the approved label.

9. The computer-implemented method of claim 1, wherein applying the label comprises applying a label selected from a group of labels consisting of:
a binary label that indicates the unlabeled event datum to which the binary label is being applied indicates one of a benign or a malicious action taken or result achieved in the computing environment;
a multiple class label that indicates the unlabeled event datum to which the multiple class label is being applied indicates one of a plurality of actions taken or results achieved in the computing environment; and
a multiple label that indicates the unlabeled datum to which the multiple label is being applied indicates a plurality of actions taken or results achieved in the computing environment.

10. A non-transitory computer-readable media storing computer-executable instructions that, when executed by one or more processors, cause the one or more processors to perform operations comprising:
receiving unlabeled event data associated with a computing environment;
clustering via an unsupervised machine learning model the unlabeled event data into clusters of unlabeled event data where unlabeled event data in one cluster are more similar to each other than to unlabeled event data in other clusters;
selecting a respective subset of unlabeled event data for each cluster of unlabeled event data;
translating via a large language model artificial neural network each unlabeled event datum in each respective subset of unlabeled event data into a description for the unlabeled event datum; and
applying a label via a labeling algorithm to at least one unlabeled event datum in a respective cluster responsive to and representative of the respective description for the unlabeled event datum in the respective subset, thereby transforming the at least one unlabeled event datum to a labeled event datum.

11. The non-transitory computer-readable media of claim 10 wherein applying the label via the labeling algorithm to the at least one unlabeled event datum in the respective cluster responsive to and representative of the respective description for the unlabeled event datum in the respective subset, comprises applying a label via the labeling algorithm to a plurality of unlabeled event datum in each respective cluster responsive to and representative of the respective description for the unlabeled event datum in the respective subset.

12. The non-transitory computer-readable media of claim 10 further comprising training a machine learning model to analyze and detect cybersecurity threats using the labeled event data.

13. The non-transitory computer-readable media of claim 10 wherein clustering via the unsupervised machine learning model the unlabeled event data into clusters of unlabeled event data where unlabeled event data in one cluster are more similar to each other than to unlabeled event data in other clusters, comprises clustering via the unsupervised machine learning model the unlabeled event data into clusters of unlabeled event data where unlabeled event data in one cluster are more similar to each other in terms of indicating one or both of an action taken and a result achieved in the computing environment than to unlabeled event data in other clusters.

14. The non-transitory computer-readable media of claim 10, wherein selecting the respective subset of unlabeled event data for each cluster of unlabeled event data, comprises one or both of selecting unlabeled event data of interest and filtering out known or related unlabeled event data.

15. The non-transitory computer-readable media of claim 10, wherein translating via the large language model artificial neural network each unlabeled event datum in each respective subset of unlabeled event data into the description for the unlabeled event datum, comprises translating each unlabeled event datum into one or more of: a natural language, a coded, a decoded, or a pseudo-coded, description of an action taken or a result achieved in the computing environment; a description of a usage of an executable file referenced in the unlabeled event datum; a description of the unlabeled event datum indicating a benign or a malicious action was taken or result achieved in the computing environment; a description of techniques and/or tactics used by threat actors where the unlabeled event datum indicates a malicious action was taken or result achieved in the computing environment; and a description of a level of confidence in the translation and description of the unlabeled event datum.

16. The non-transitory computer-readable media of claim 10, wherein applying the label via the labeling algorithm to the at least one unlabeled event datum in the respective cluster responsive to and representative of the respective description for the unlabeled event datum in the respective subset, thereby transforming the at least one unlabeled event datum to the labeled event datum, comprises:
proposing the label via the labeling algorithm;
receiving user input to approve the proposed label; and
applying the approved label.

17. The non-transitory computer-readable media of claim 10, wherein applying the label comprises applying a label selected from a group of labels consisting of:
a binary label that indicates the unlabeled event datum to which the binary label is being applied indicates one of a benign or a malicious action taken or result achieved in the computing environment;
a multiple class label that indicates the unlabeled event datum to which the multiple class label is being applied indicates one of a plurality of actions taken or results achieved in the computing environment; and
a multiple label that indicates the unlabeled datum to which the multiple label is being applied indicates a plurality of actions taken or results achieved in the computing environment.

18. A system comprising:
a memory to store instructions;
a processor to execute the instructions stored in the memory for:
receiving unlabeled event data associated with a computing environment;
clustering via an unsupervised machine learning model the unlabeled event data into clusters of unlabeled event data where unlabeled event data in one cluster are more similar to each other than to unlabeled event data in other clusters;
selecting a respective subset of unlabeled event data for each cluster of unlabeled event data;
translating via a large language model artificial neural network each unlabeled event datum in each respective subset of unlabeled event data into a description for the unlabeled event datum; and
applying a label via a labeling algorithm to at least one unlabeled event datum in a respective cluster responsive to and representative of the respective description for the unlabeled event datum in the respective subset, thereby transforming the at least one unlabeled event datum to a labeled event datum.

19. The system of claim 18 wherein applying the label via the labeling algorithm to the at least one unlabeled event datum in the respective cluster responsive to and representative of the respective description for the unlabeled event datum in the respective subset, comprises applying a label via the labeling algorithm to a plurality of unlabeled event datum in each respective cluster responsive to and representative of the respective description for the unlabeled event datum in the respective subset.

20. The system of claim 18 wherein clustering via the unsupervised machine learning model the unlabeled event data into clusters of unlabeled event data where unlabeled event data in one cluster are more similar to each other than to unlabeled event data in other clusters, comprises clustering via the unsupervised machine learning model the unlabeled event data into clusters of unlabeled event data where unlabeled event data in one cluster are more similar to each other in terms of indicating one or both of an action taken and a result achieved in the computing environment than to unlabeled event data in other clusters.
